(19) United States
(12) Patent Application Publication
(10) Pub. No.: US 2022/0371743 A1
(43) Pub. Date: Nov. 24, 2022

(54) TANK SYSTEM COMPRISING A CHASSIS, A TANK FOR DIHYDROGEN, AND MEANS FOR ATTACHING THE TANK TO THE CHASSIS

(71) Applicants: Airbus SAS, BLAGNAC (FR); Airbus Operations SAS, Toulouse (FR); Airbus Operations S.L., Getafe (ES)

(72) Inventors: Julien ALLAIN, BLAGNAC (FR); Thomas DEFORET, TOULOUSE (FR); Julien LAVERNE, TOULOUSE (FR); Emmanuel VARDELLE, TOULOUSE (FR); Kotaro FUKASAKU, TOULOUSE (FR); Carlos FLORES HERNANDEZ, GETAFE (ES)

(21) Appl. No.: 17/747,200

(22) Filed: May 18, 2022

(30) Foreign Application Priority Data
May 20, 2021 (FR) 2105251

(51) Int. Cl. B64D 37/04; B64D 37/30

(52) U.S. Cl. CPC B64D 37/04; B64D 37/30; B64D 27/24

(57) ABSTRACT

A tank system for an aircraft, including a tank including an inner enclosure including a closed inner skin configured to store dihydrogen and an outer enclosure including an outer skin that surrounds the inner enclosure, a chassis including a front frame at a front end of the tank, and an attachment arrangement which attaches the outer skin of the outer enclosure to the front frame. A system of this kind makes it possible to react forces through the outer skin, thus reducing a complexity of the chassis.

### CROSS-REFERENCES TO RELATED APPLICATIONS

This application claims the benefit of the French patent application No. 2105251 filed on May 20, 2021, the entire disclosures of which are incorporated herein by way of reference.

### FIELD OF THE INVENTION

The present invention relates to a tank system for an aircraft, the tank system comprising a chassis, a tank for dihydrogen and attachment means that serve to attach the tank to the chassis. The invention also relates to an aircraft having at least one such tank system.

### BACKGROUND OF THE INVENTION

In order to move, an aircraft comprises a propulsion system comprising a motor and a propeller. The motor generates a rotary movement that is transmitted to the propeller.

It is known to use an electric motor in order to set the propeller in motion, and it is also known to use a fuel cell in order to power the electric motor.

In order to power the fuel cell, the aircraft has an on-board hydrogen tank that is attached to the structure of the aircraft. The structure is an assembly of struts which are attached to one another, and around which are attached cowls forming an aerodynamic fairing. The tank is attached to the structure, but there is a need to find an alternative attachment method which, among other considerations, makes it possible to reduce the number of struts in order to save weight.

### SUMMARY OF THE INVENTION

One aim of the present invention is to propose a tank system which comprises a chassis, a tank for dihydrogen and attachment means, and which has an optimized arrangement.

To that end, a tank system for an aircraft is proposed, said tank system having:

a tank comprising an inner enclosure comprising a closed inner skin configured to store dihydrogen and an outer enclosure comprising an outer skin that surrounds the inner enclosure and taking the form of a cylinder of revolution about a longitudinal axis X,

a chassis comprising a frame at one end of the tank, and

attachment means which attach the outer skin of the outer enclosure to the frame and which comprise three attachment means of a first type distributed about the outer enclosure at 3 o'clock, 12 o'clock and 9 o'clock as viewed along the longitudinal axis X and a plurality of attachment means of the second type arranged between the attachment means of the first type, wherein each attachment means of the second type comprises a two-link-point connecting rod, one of the link points providing attachment to the frame and the other link point providing attachment to the outer skin of the outer enclosure, and wherein the two link points of a given connecting rod are aligned parallel to the longitudinal axis X.

A system of this kind makes it possible to react forces through the outer skin, thus reducing the complexity of the chassis.

Advantageously, the attachment means of the first type at 12 o'clock comprises a three-link-point connecting rod, two of these link points attaching to the frame and a third link point attaching to the outer skin of the outer enclosure.

Advantageously, each link point between the connecting rod and the frame takes the form of a male clevis of the connecting rod, a female clevis which is secured to the frame and into which the male clevis fits, and a pin passing through the female clevis and the male clevis, and the axis of the pin is aligned in a direction that is generally radial with respect to the longitudinal axis X.

Advantageously, the third link point between the connecting rod and the outer skin of the outer enclosure takes the form of a ball joint embodied by a peg of the connecting rod, whose axis is parallel to the longitudinal axis X, and which fits into a ball that is secured to the outer skin.

According to one particular embodiment, the attachment means of the first type at 3 o'clock and at 9 o'clock are identical to the attachment means of the first type at 12 o'clock.

According to one particular embodiment, each attachment means of the first type at 3 o'clock and at 9 o'clock comprises two pairs of connecting rods, each connecting rod is a two-link-point connecting rod, one of the link points providing attachment to the frame and the other link point providing attachment to the outer skin of the outer enclosure, the two pairs of connecting rods of a given attachment means of the first type are arranged on either side of a median plane passing through the longitudinal axis X, the two pairs come closer together at their link points with the outer skin, and the two pairs are further apart at their link points with the frame.

Advantageously, each link point of the connecting rod takes the form of a female clevis of the connecting rod, a male clevis which is secured respectively to the frame and to the outer skin of the outer enclosure and onto which the female clevis fits, and a pin passing through the female clevis and the male clevis, and the axis of the pin is aligned in a direction that is generally tangential with respect to the longitudinal axis X.

Advantageously, the outer skin comprises stiffeners that extend parallel to the longitudinal axis X, and each male clevis which is secured to the outer skin of the outer enclosure, and onto which a female clevis of the connecting rod fits, is one of the stiffeners.

The invention also proposes an aircraft having at least one tank system according to one of the preceding variants.

### BRIEF DESCRIPTION OF THE DRAWINGS

The abovementioned features of the invention, along with others, will become more clearly apparent upon reading the following description of one exemplary embodiment, said description being given with reference to the appended drawings, in which:

FIG. 1 is a perspective view of an aircraft having a plurality of propeller propulsion systems according to the invention,

FIG. 2 is a schematic sectional depiction of a propeller propulsion system having an on-board tank system according to the invention,

FIG. 3 is a perspective view of a front end of the tank system according to the invention,

FIG. 4 is an enlarged view of a three-point connecting rod as per detail IV in

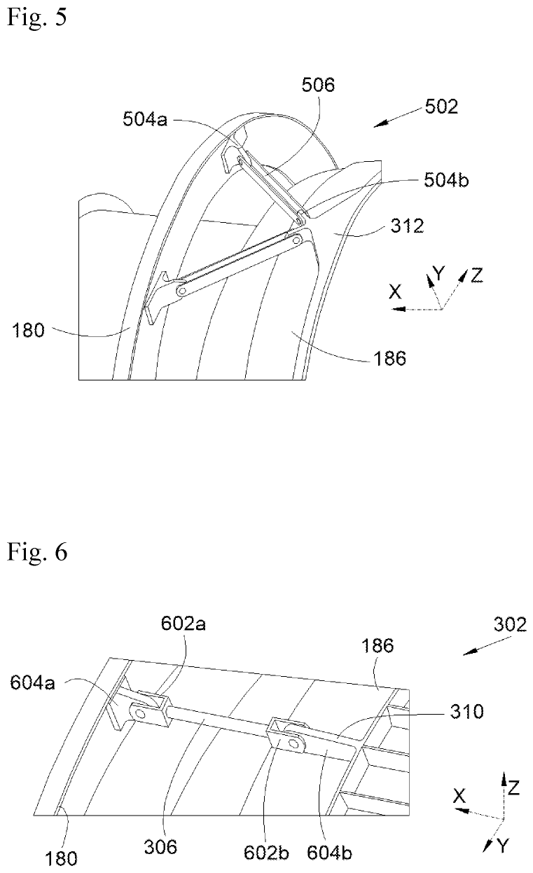

FIG. 3 and according to a first embodiment of the invention,

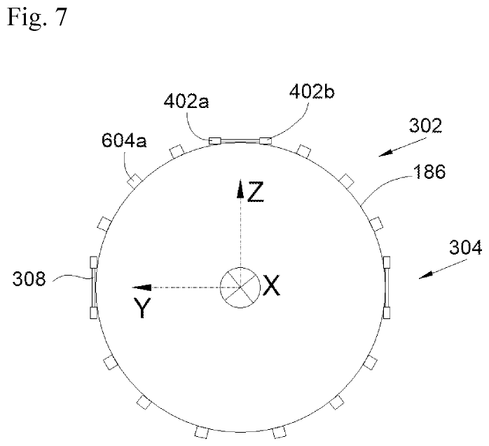

FIG. 5 is a view similar to that of FIG. 4 for a second embodiment of the invention,

FIG. 6 is an enlarged view of a tie rod as per detail VI in FIG. 3, and

FIG. 7 is a schematic depiction of a rear view of the tank system according to the invention, without the rear frame.

### DETAILED DESCRIPTION OF THE PREFERRED EMBODIMENTS

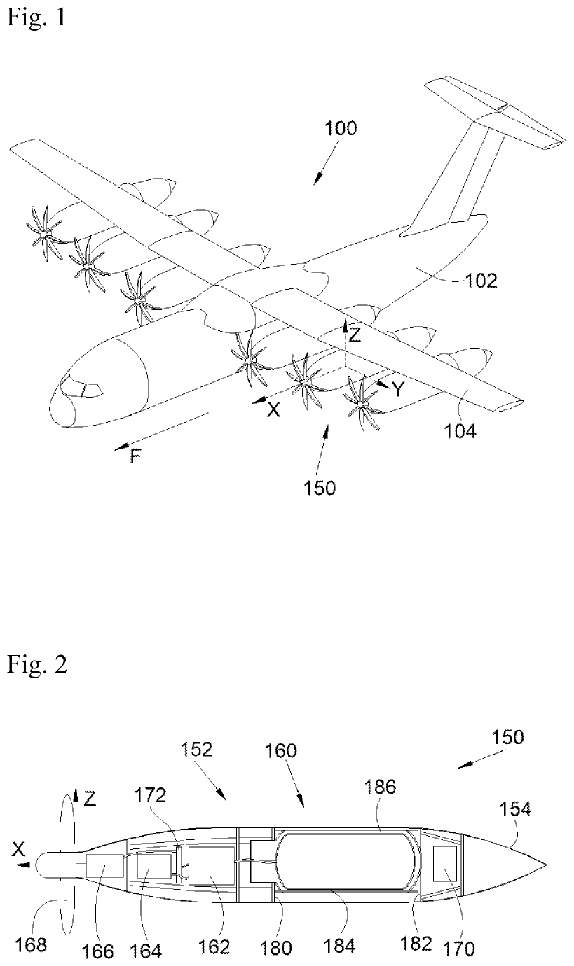

In the following description, terms relating to a position are considered in relation to an aircraft in a position of forward movement, i.e., as shown in FIG. 1 in which the arrow F shows the direction of forward movement of the aircraft.

FIG. 1 shows an aircraft 100 that has a fuselage 102 on either side of which is attached a wing 104. At least one propeller propulsion system 150 is attached under each wing 104. In the embodiment of the invention shown in FIG. 1, there are three propulsion systems 150 per wing 104.

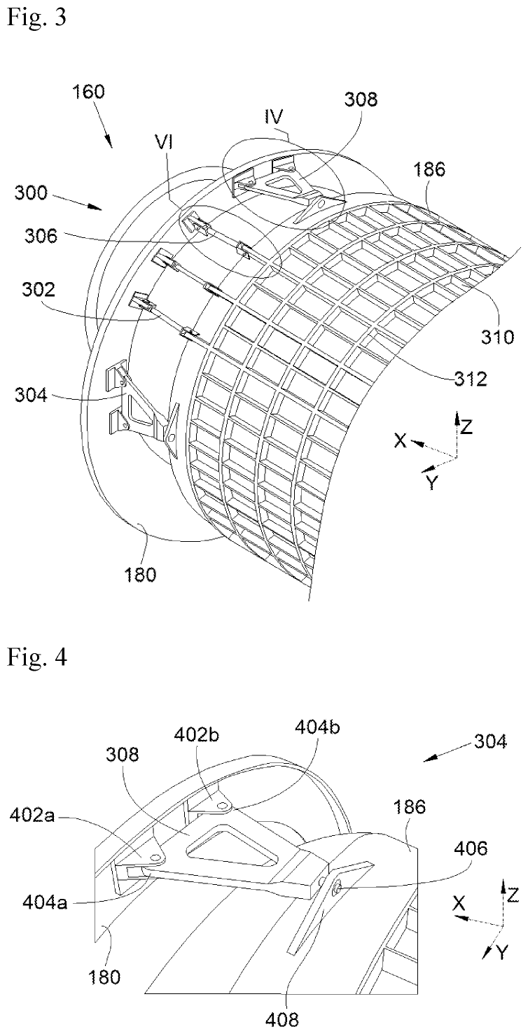

FIG. 2 shows the propulsion system 150 that comprises a chassis 152 around which are attached cowls 154 constituting the aerodynamic fairing of the propulsion system 150.

The chassis 152 is attached to the wing 104 by any appropriate fastening means, which are not shown in the figures; these can for example be fittings, connecting rods, nuts, etc.

In the embodiment of the invention shown in FIG. 2, the propulsion system 150 comprises, attached to the chassis 152, a tank 160, a fuel cell 162, an air supply system 164, an electric motor 166, a propeller 168, a cooling system 170 and an electrical management system 172.

In the following description, and by convention, the X direction is the longitudinal axis of the tank 160, with positive orientation in the direction of forward movement of the aircraft 100; the Y direction is the transverse axis of the reservoir 160, which is horizontal when the aircraft is on the ground; and the Z direction is the vertical axis or vertical height when the aircraft is on the ground; these three axes X, Y and Z being mutually orthogonal. The axis of rotation of the propeller is, in this case, parallel to the longitudinal axis X.

The air supply system 164 takes ambient air, for example by means of a scoop in a cowl 154, and filters it before sending it to the fuel cell 162 through an air supply duct.

The tank 160 contains dihydrogen which is sent to the fuel cell 162 through a dihydrogen supply duct.

The fuel cell 162 is a cell in which an electric voltage is generated by virtue of the oxidation of a reducing fuel, in this case the dihydrogen, on one electrode, combined with the reduction of an oxidant, in this case the oxygen from the air, on the other electrode.

The electrical current generated by the fuel cell 162 is brought to the electrical management system 172 through electrical cables. The electrical management system 172 comprises, for example, a controller with an electrical converter which converts a direct current, produced by the fuel cell 162, into a direct or alternating current, which is sent to the electric motor 166. The conversion to direct or alternating current depends on the type of electric motor used.

At the output of the electrical management system 172, the electric current is conveyed through electric cables to the electric motor 166, and the propeller 168 is attached to the output shaft of the electric motor 166, possibly through a gearbox.

The cooling system 170 provides thermal management of the elements in the propulsion system 150.

The present invention relates more particularly to the attachment of the tank 160 to the chassis 152.

The chassis 152 comprises a plurality of frames distributed along the longitudinal axis X and joists connecting the frames to one another so as to form a skeleton on which the cowls 154 and the various elements of the propulsion system 150 are attached.

The chassis 152 comprises, among other things, a front frame 180 and a rear frame 182, the front frame 180 being at the level of the front end of the tank 160, and the rear frame 182 being at the level of the rear end of the tank 160. In this case, the front frame 180 and the rear frame 182 are each in the form of a crown arranged around the corresponding end of the tank 160. Although in this case both crowns are circular, they may have different shapes.

FIGS. 3 to 7 show the front frame 180 and the tank 160 with attachment means 300 that attach the tank 160 the front frame 180, but identical installation may be implemented between the tank 160 and the rear frame 182 and, in general terms, installation of this kind may be brought about between the tank 160 and one and/or the other of the frames 180, 182.

The tank 160 comprises an inner enclosure 184 that comprises a closed inner skin in which the dihydrogen is stored, and an outer enclosure 186 which comprises an outer skin that surrounds the inner enclosure 184.

In the embodiment presented here, the inner enclosure 184 takes the form of a cylinder of revolution which is closed at its ends and whose axis is the longitudinal axis X.

Similarly, the outer enclosure 186 takes the form of a cylinder of revolution whose axis is the longitudinal axis X, and which is also closed at its ends so as to provide better rigidity.

The inner enclosure 184 is held inside the outer enclosure 186 by any appropriate means, for example spacers attached between the inner skin and the outer skin.

The outer enclosure 186 is a structural element, that is to say, it is dimensioned so as to transmit relatively large forces without deforming, whereas the inner enclosure 184 serves only as a container for the dihydrogen.

In order to strengthen the structure of the outer enclosure 186, the outer skin comprises stiffeners 310 and 312, in particular first stiffeners 310 which extend parallel to the longitudinal axis X and second stiffeners 312 which takes the form of crowns around the outer skin.

The attachment means 300 are attached between the front frame 180 and the outer skin of the outer enclosure 186 and, as specified hereinabove, the attachment means 300 may be attached between the rear frame 182 and the outer skin of the outer enclosure 186 and, in general terms, the attachment means 300 attached the outer skin of the outer enclosure 186 to one and/or the other of the frames 180, 182.

Thus, external forces acting on the propulsion system 150 are transmitted to the chassis 152 and, in particular, to either the front frame 180 or the rear frame 182 and then, through the attachment means 300 and the outer enclosure 186, to the other frame 182 or 180, and finally to the wing 104 through the fastening means.

A tank system according to the invention therefore comprises the tank 160, the chassis 152 with a frame 180, 182 and the attachment means 300 which attach the outer skin of the outer enclosure 186 to the frame 180, 182.

Therefore, an installation of this kind does not require joists along the outer skin, that is to say, in this case between the front frame 180 and the rear frame 182, resulting in space and weight savings.

The description of the attachment means 300 is given in relation to the front frame 180, but it may equally apply to the rear frame 182.

The attachment means 300 comprise a set of attachment means of a first type 304 and a set of attachment means of a second type 302.

In the embodiment of FIG. 3 and FIG. 4, each attachment means of the first type 304 comprises a three-link-point connecting rod 308, two of these link points attaching to the front frame 180 and a third link point attaching to the outer skin of the outer enclosure 186.

As shown in FIG. 4, each link point between the connecting rod 308 and the front frame 180 takes the form of a male clevis 404a-b of the connecting rod 308, a female clevis 402a-b which is secured to the front frame 180 and into which the male clevis 404a-b fits, and a pin passing through the female clevis 402a-b and the male clevis 404a-b. The axis of the pin is aligned in a direction that is generally radial with respect to the longitudinal axis X. Preferably, the connection between the female clevis 402a-b and the associated male clevis 404a-b is in the form of a ball joint.

In the embodiment of the invention shown here, each female clevis 402a-b that is secured to the front frame 180 takes the form of a fitting which is attached to the front frame 180, for example by welding.

As shown in FIG. 4, the third link point between the connecting rod 308 and the outer skin of the outer enclosure 186 based the form of a ball joint, embodied in this case by a peg (also termed “spigot”) of the connecting rod 308, whose axis is parallel to the longitudinal axis X and which fits into a ball that is secured to the outer skin; in this case the ball is inserted into a membrane 408 of the outer skin, this extending radially relative to the longitudinal axis X.

There are three attachment means of the first type 304 which are distributed about the outer enclosure 186 at 3 o'clock, 12 o'clock and 9 o'clock as viewed along the longitudinal axis X.

The two attachment means of the first type 304 at 3 o'clock and 9 o'clock serve to react forces along the vertical axis Z, and the attachment means of the first type 304 at 12 o'clock serves to react forces along the transverse axis Y.

In the embodiment if the invention of FIG. 3, the attachment means of the first type 304 at 3 o'clock and at 9 o'clock are identical to the attachment means of the first type 304 at 12 o'clock.

The attachment means 502 of FIG. 5 is a variant for an attachment means of the first type for reacting forces along the vertical axis Z, that is to say, for the attachment means of the first type arranged at 3 o'clock and 9 o'clock.

The attachment means of the first type 502 comprises two pairs of connecting rods 506, wherein each connecting rod 506 is a two-link-point connecting rod, one of the link points attaching to the front frame 180 and the other link point attaching to the outer skin of the outer enclosure 186.

The two pairs of connecting rods 506 of a given attachment means of the first type 502 are arranged on either side of a median plane passing through the longitudinal axis X, the two pairs coming closer together at their link points with the outer skin, and the two pairs being further apart at their link points with the front frame 180. The angle of inclination of each connecting rod 506 with respect to the median plane is, for example, on the order of 45°.

As shown in FIG. 5, the two connecting rods 506 of a given attachment means of the first type 502 form, at their two ends, a female clevis into which a male clevis 504a-b fits, these being respectively secured to the front frame 180 and to the outer skin, their axis being perpendicular to the direction of the connecting rods 506.

In the embodiment of the invention shown here, each male clevis 504a that is secured to the front frame 180 takes the form of a fitting which is attached to the front frame 180, for example by welding.

In the embodiment of the invention shown here, each male clevis 504b that is secured to the skin takes the form of an extension of the second stiffeners 312.

Each attachment means of the second type 302 comprises a two-link-point connecting rod 306, one of the link points attaching to the front frame 180 and the other link point attaching to the outer skin of the outer enclosure 186. The two attachment points of a given connecting rod 306 are aligned parallel to the longitudinal axis X, which makes it possible to react forces along the longitudinal axis X.

As shown in FIG. 6, each link point of the connecting rod 306 in this case takes the form of a female clevis 602a-b of the connecting rod 306, a male clevis 604a-b which is respectively secured to the front frame 180 and the outer skin of the outer enclosure 186 and onto which the female clevis 602a-b fits, and a pin passing through the female clevis 602a-b and the male clevis 604a-b. The axis of the pin is aligned in a direction that is generally tangential with respect to the longitudinal axis X. Preferably, the connection between the female clevis 602a-b and the associated male clevis 604a-b is in the form of a ball joint.

In order to make it possible to adapt the length of each connecting rod 306 according to the position of the front frame 180 and of the outer enclosure 186, each connecting rod 306 is a length-adjustable connecting rod.

In the embodiment of the invention shown here, each male clevis 604a that is secured to the front frame 180 takes the form of a fitting which is attached to the front frame 180, for example by welding.

In the embodiment of the invention presented here, each male clevis 604b which is secured to the outer skin of the outer enclosure 186, and onto which a female clevis 602a-b of the connecting rod 306 fits, is one of the first stiffeners 310.

In the embodiment of the invention presented here, there are twelve attachment means of the second type 302, that is to say, twelve connecting rods 306, which are distributed about the longitudinal axis X, but of course a different number is conceivable, depending on the dimensions of the reservoir 160. The attachment means of the second type 302 are arranged between the attachment means of the first type 304, 502.

In the above description, the propulsion system 150 forms an assembly which is attached beneath a wing 104, and the chassis 152 is the chassis of the propulsion system 150, but other arrangements are possible. For example, it is possible to directly integrate the propulsion system 150 into the wing 104 and the chassis 152 becomes part of the chassis of the wing 104.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A tank system for an aircraft, the tank system comprising:
a tank comprising an inner enclosure comprising a closed inner skin configured to store dihydrogen and an outer enclosure comprising an outer skin that surrounds the inner enclosure and formed as a cylinder of revolution about a longitudinal axis,
a chassis comprising a frame at one end of the tank, and
attachment means which attach the outer skin of the outer enclosure to the frame and which comprise three attachment means of a first type distributed angularly about the outer enclosure at 3 o'clock, 12 o'clock and 9 o'clock as viewed along the longitudinal axis and a plurality of attachment means of a second type arranged between the attachment means of the first type, wherein each attachment means of the second type comprises a two link point connecting rod, one of the two link points providing attachment to the frame and another of the two link points providing attachment to the outer skin of the outer enclosure, and wherein the two link points of a given connecting rod are aligned parallel to the longitudinal axis.

2. The tank system according to claim 1, wherein the attachment means of the first type at 12 o'clock comprises a three link point connecting rod, two of the three link points attaching to the frame and a third link point of the three link points attaching to the outer skin of the outer enclosure.

3. The tank system according to claim 2,
wherein each link point between the connecting rod and the frame takes is formed as a male clevis of the connecting rod, a female clevis which is secured to the frame and into which the male clevis fits, and a pin passing through the female clevis and the male clevis, and
wherein the axis of the pin is aligned in a direction that is generally radial with respect to the longitudinal axis.

4. The tank system according to claim 3, wherein the third link point between the connecting rod and the outer skin of the outer enclosure is formed as a ball link point embodied by a peg of the connecting rod, having an axis parallel to the longitudinal axis and which fits into a ball that is secured to the outer skin.

5. The tank system according to claim 2, wherein the attachment means of the first type at 3 o'clock and at 9 o'clock are identical to the attachment means of the first type at 12 o'clock.

6. The tank system according to claim 2,
wherein each attachment means of the first type at 3 o'clock and at 9 o'clock comprises two pairs of connecting rods,
wherein each connecting rod is a two link point connecting rod, one of the two link points providing attachment to the frame and another of the two link points providing attachment to the outer skin of the outer enclosure,
wherein the two pairs of connecting rods of a given attachment means of the first type are arranged on either side of a median plane passing through the longitudinal axis,
wherein the two pairs come closer together at their link points with the outer skin, and
wherein the two pairs are further apart at their link points with the frame.

7. The tank system according to claim 1,
wherein each link point of each connecting rod is formed as a female clevis of the connecting rod, a male clevis which is secured respectively to the frame and to the outer skin of the outer enclosure and onto which the female clevis fits, and a pin passing through the female clevis and the male clevis, and
wherein an axis of the pin is aligned in a direction that is generally tangential with respect to the longitudinal axis.

8. The tank system according to claim 7,
wherein the outer skin comprises stiffeners that extend parallel to the longitudinal axis, and
wherein each male clevis which is secured to the outer skin of the outer enclosure, and onto which a female clevis of the connecting rod fits, is one of the stiffeners.

9. An aircraft having at least one tank system according to claim 1.
